(19) United States
(12) Patent Application Publication
(10) Pub. No.: US 2015/0350455 A1
(43) Pub. Date: Dec. 3, 2015

(54) PROXIMITY SERVICE

(71) Applicant: BROADCOM CORPORATION, Irvine, CA (US)

(72) Inventors: Timo KOSKELA, Oulu (FI); Matti JOKIMIES, Salo (FI); Samuli TURTINEN, Ii (FI); Sami-Jukka HAKOLA, Kempele (FI)

(21) Appl. No.: 14/759,557

(22) PCT Filed: Jan. 7, 2014
(86) PCT No.: PCT/IB2014/058100

§ 371 Date: Jul. 7, 2015

(30) Foreign Application Priority Data
Jan. 7, 2013 (GB) 1300217.5

(51) Int. Cl. H04M 15/00; H04W 76/02; H04W 4/00

(52) U.S. Cl. CPC H04M 15/64; H04M 15/88; H04M 15/8214; H04W 4/008; H04W 76/023

(57) ABSTRACT

A method comprising monitoring if a charging event related to a proximity service performed by an apparatus performing the method occurs, collecting the occurred at least one charging event, and forwarding the collected at least one charging event to a charging data function.

### TECHNICAL FIELD

The present invention relates to charging of a proximity service. In particular, the present invention relates to an apparatus, a method, and a computer program product related to proximity based communication such as device to device communication.

### BACKGROUND

### Abbreviations

3GPP 3rd Generation Partnership Project
AS Access Stratum
CDF Charging Data Function
CDR Charging Data Record
CGF Charging Gateway Function
CTF Charging Trigger Function
D2D Device-to-Device
EPC Evolved Packet Core
GGSN Gateway GSN
GPRS General Packet Radio Service
GSM Global System for Mobile Communication
GSN GPRS Support Node
IMS IP Multimedia Subsystem
IP Internet Protocol
LTE Long Term Evolution
MM Multimedia Message
MME Mobility Management Entity
MMS Multimedia Messaging Service
MO Mobile originated
MT Mobile terminated
NAS Non-Access Stratum
OCF Online Charging Function
OCS Online Charging System
PDN Packet Data Network
PLMN Public Land Mobile Network
ProSe Proximity Services
RRC Radio Resource Control
S-GW Serving Gateway
SGSN Serving GSN
SIM Subscriber Identity Module
TS Technical Specification
UE User Equipment
UICC Universal Integrated Circuit Card
UMTS Universal Mobile Telecommunication Service
USIM UMTS SIM

Future LTE systems may incorporate Proximity Services (ProSe) features. ProSe is an extension that allows UEs to discover each other using direct radio signals as well as UEs to setup a direct communication link between them to carry application data without conveying such through the network.

Current LTE lacks methods and mechanisms for gathering data from UE discovery and D2D communications for charging purposes.

ProSe specific charging is useful and might even be required at least because of the following aspects:

D2D communications may use licensed spectrum, i.e., spectrum paid by operator. Typically, the radio resources are scarce. Therefore some fee may be justified, to discourage waste of radio resources, and to distribute the costs fairly across the users.

CDRs may be generated, even though the end user is never billed for the call/data transfer. This may be done either for statistical purposes or because the bill is paid by someone else. For example, currently, in some networks, CDRs are generated for emergency calls, even though the end user is never billed for them, but the operators may be compensated.

GSM/UMTS/EPC networks provide functions that implement offline and/or online charging mechanisms on bearer level (e.g. EPC), subsystem (e.g. IMS) level, and service (e.g. MMS) level. In order to support these charging mechanisms, the network performs real-time monitoring of resource usage on the above three levels in order to detect the relevant chargeable events [1].

In offline charging, the resource usage is reported from the network to the Billing Domain after the resource usage has occurred. In online charging, a subscriber account, located in an online charging system, is queried prior to granting permission to use the requested network resource(s) [1].

Typical examples of network resource usage are a voice call of certain duration, the transport of a certain volume of data, or the submission of a MM of a certain size. The network resource usage requests may be initiated by the UE (MO case) or by the network (MT case) [1].

The Charging Trigger Function (CTF) generates charging events based on the observation of network resource usage. In conventional network elements and service elements that provide charging information, the CTF is a focal point for collecting the information pertaining to chargeable events within the network element, assembling this information into matching charging events, and sending these charging events towards the Charging Data Function. It is made up of two functional blocks:

Accounting Metrics Collection; and

Accounting Data Forwarding [1].

The Charging Data Function (CDF) receives charging events from the Charging Trigger Function via the Rf reference point. It then uses the information contained in the charging events to construct CDRs [1].

The CDRs produced by the CDF are transferred immediately to the Charging Gateway Function (CGF) via the Ga reference point. The CGF acts as a gateway between the network (e.g. 3GPP network) and the Billing Domain [1].

On the other hand, the above-mentioned set-up of network entities, described in ref [1], is a reference model, which does not describe all actual implementations. In some actual implementations, CTF and CDF are integrated in one or more network elements. This is reflected, e.g., in ref [2], where Ga is specified as an interface between a CDR transmitting unit (e.g. network elements like an SGSN, S GW, PDN GW or a GGSN) and a CDR receiving functionality (a CGF). I.e., in these implementations, CTF and CDF are parts of the one or more network elements.

### [1] 3GPP TS 32.240 v.11.5.0 (2012-09)

### [2] 3GPP TS 23.060 v. 11.3.0 (2012-09)

### SUMMARY

According to a first aspect of the invention, there is provided apparatus for use in charging of a proximity service for a terminal device, the apparatus comprising a processing system configured to cause the apparatus to:

monitor whether a charging event related to a proximity service performed by the apparatus occurs;

collect the occurred at least one charging event; and

forward the collected at least one charging event to a charging data function.

According to embodiments, there is provided apparatus, comprising monitoring means adapted to monitor if a charging event related to a proximity service performed by the apparatus occurs; collecting means adapted to collect the occurred at least one charging event; forwarding means adapted to forward the collected at least one charging event to a charging data function.

According to a second aspect of the invention, there is provided apparatus for use in charging of a proximity service for a terminal device, the apparatus comprising a processing system configured to cause the apparatus to:

generate a charging data record based on at least one charging event related to a proximity service of a terminal device, wherein the at least one charging event is received from the terminal device; and

forward the charging data record to a charging gateway function.

According to embodiments, there is provided an apparatus, comprising generating means adapted to generate a charging data record based on at least one charging event related to a proximity service of a terminal device, wherein the at least one charging event is received from the terminal device; forwarding means adapted to forward the charging data record to a charging gateway function.

According to a third aspect of the invention, there is provided apparatus for use in charging of a proximity service for a terminal device, the apparatus comprising a processing system configured to cause the apparatus to provide an instruction to a terminal device to adapt at least one of:

monitoring whether a charging event occurs, wherein the charging event is related to a proximity service executed by the terminal device;

collecting the occurred at least one charging event; and

forwarding the collected at least one charging event to a charging data function.

According to embodiments, there is provided an apparatus, comprising providing means adapted to provide an instruction to a terminal device to adapt at least one of monitoring if a charging event occurs, wherein the charging event is related to a proximity service executed by the terminal device, collecting the occurred at least one charging event, and forwarding the collected at least one charging event to a charging data function.

According to a fourth aspect of the invention, there is provided a method for use in charging of a proximity service for a terminal device, the method comprising:

monitoring if a charging event related to a proximity service performed by an apparatus performing the method occurs;

collecting the occurred at least one charging event;

forwarding the collected at least one charging event to a charging data function.

According to an fifth aspect of the invention, there is provided a method for use in charging of a proximity service for a terminal device, the method comprising:

generating a charging data record based on at least one charging event related to a proximity service of a terminal device, wherein the at least one charging event is received from the terminal device; and

forwarding the charging data record to a charging gateway function.

According to a sixth aspect of the invention, there is provided a method for use in charging of a proximity service for a terminal device, the method comprising providing an instruction to a terminal device to adapt at least one of:

monitoring whether a charging event occurs, wherein the charging event is related to a proximity service executed by the terminal device;

collecting the occurred at least one charging event; and

forwarding the collected at least one charging event to a charging data function.

Each of the methods aspects may be a method of charging for proximity based communication.

According to a seventh aspect of the invention, there is provided a computer program product comprising a set of instructions which, when executed on an apparatus, is configured to cause the apparatus to carry out a method according to any of the method aspects. The computer program product may be embodied as a computer readable medium.

According to some embodiments of the invention, for example at least the following advantages are achieved:

Charging of device to device communication is enabled. The solution fits into the conventional charging related architecture.

It is to be understood that any of the above modifications can be applied singly or in combination with the respective aspects to which they refer, unless they are explicitly stated as excluding alternatives.

Further features and advantages of the invention will become apparent from the following description of preferred embodiments of the invention, given by way of example only, which is made with reference to the accompanying drawings.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows an overview of physical and logical functionalities according to an embodiment of the invention;

FIG. 2 shows a ProSe network architecture according to an embodiment of the invention;

FIG. 3 shows a sequence diagram depicting the ProSe/D2D CTF and ProSe/D2D CDF functionalities and interaction (protocol behaviour) according to an embodiment of the invention;

FIG. 4 shows an apparatus according to an embodiment of the invention;

FIG. 5 shows a method according to an embodiment of the invention;

FIG. 6 shows an apparatus according to an embodiment of the invention;

FIG. 7 shows a method according to an embodiment of the invention;

FIG. 8 shows an apparatus according to an embodiment of the invention;

FIG. 9 shows a method according to an embodiment of the invention; and

FIG. 10 shows a method according to the invention.

### DETAILED DESCRIPTION

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to some embodiments of the invention, the network operator is able to charge Proximity Services (ProSe) usage, e.g. in future LTE networks. Such a system has capabilities to generate Charging Data Records (CDRs) of Proximity Services (ProSe) usage.

Preferably, methods and mechanisms are designed so that a user is not able to tamper with the CDR data.

In the following, the term ProSe/D2D preferably refers to communication events and sessions between UEs using direct radio signals between the UEs (also called D2D). It may also refer to other ProSe specific communications like local switch. However, for these communications, charging functions could be implemented in the network, too.

According to the ProSe/D2D charging mechanism of some embodiments of the invention, the existing 3GPP charging architecture is maintained, and the following new items are introduced (details are described further below):

The UE contains actual charging event creation which is a part of the conventional CTF functionality;

CDF functionality is integrated with a network element or as a separate server entity;

The CTF functionality of the UE may be preconfigured and fixed. Alternatively, one of the network elements or a separate server entity may contain control functionality for the CTF of the UE. Thus, the conventional CTF functionality is split between UE and the network element or the server. The network element or the server may be the same as the one on which the CDF functionality is implemented.

Accordingly, one or more new interfaces between UE and the corresponding functions on the network side are introduced; they may be implemented above existing air interface protocol stack.

In some embodiments of the invention, handling and processing of other (i.e., non-D2D related) ProSe charging events is integrated with ProSe/D2D CDF. In this case, the CDF may be called a “ProSe CDF” (that is, a CDF covering all ProSe related CDF operations, not only D2D operations).

Note that “server” in the present context is related to the corresponding software function which may be implemented on a separate hardware but does not necessarily require the separate hardware. Instead, it may be implemented e.g. on a hardware of a network element.

According to some embodiments of the invention, the Charging Triggering Function (CTF) for the ProSe-enabled UEs is implemented in a master-slave structure. The master CTF of the UE is located in the network side taking care of configuration and control of the slave CTF which is located at the UE, preferably in close operation with the ProSe entity. The slave CTF carries out ProSe specific charging functions that comprise for instance keeping track of ProSe discovery events and ProSe/D2D communication data volumes, etc. In general, the ProSe/D2D charging events may be the same as conventionally known such as call duration, data volume, type of communication, etc.

The slave CTF may be preconfigured, or may be configured by a master CTF. If the CTF configuration is fixed and an (external) control of the slave is not required (e.g. start/stop of the slave), a master CTF is not required.

In some embodiments of the invention, a master CTF functionality is provided on the network side: It enables configuration and/or control of slave CTF at the UE when ProSe is enabled for the UE, including reconfiguration when ProSe related charging configuration changes.

On the network side, according to some embodiments of the invention, CDF functionality is implemented which performs receiving and modifying D2D data (D2D charging events) from the slave CTF at the UE and sending the data to the CGF over Ga interface. This entity may be called ProSe/D2D CDF. It may comprise the master CTF functionality, too (if available).

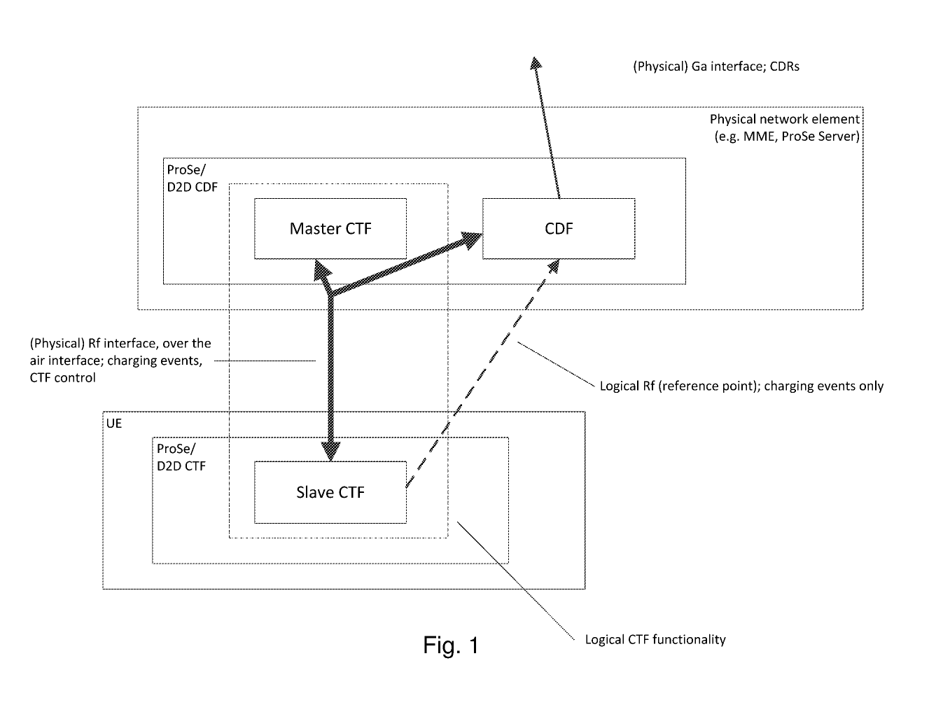

An overview of physical and logical functionalities according to an embodiment of the invention is illustrated in FIG. 1. The CTF function is split into master CTF (on network side, top part, e.g. ProSe server or MME) and slave CTF (on UE side, bottom part). In this embodiment, master CTF and CDF are named together ProSe/D2D CDF, and slave CTF is named ProSe/D2D CTF. Charging events are transmitted via the logical reference point from slave CTF to CDF. A physical interface is provided from slave CTF to both master CTF and CDF. This interface comprises an air interface. Via conventional Ga interface, CDF provides the generated CDRs to CGF.

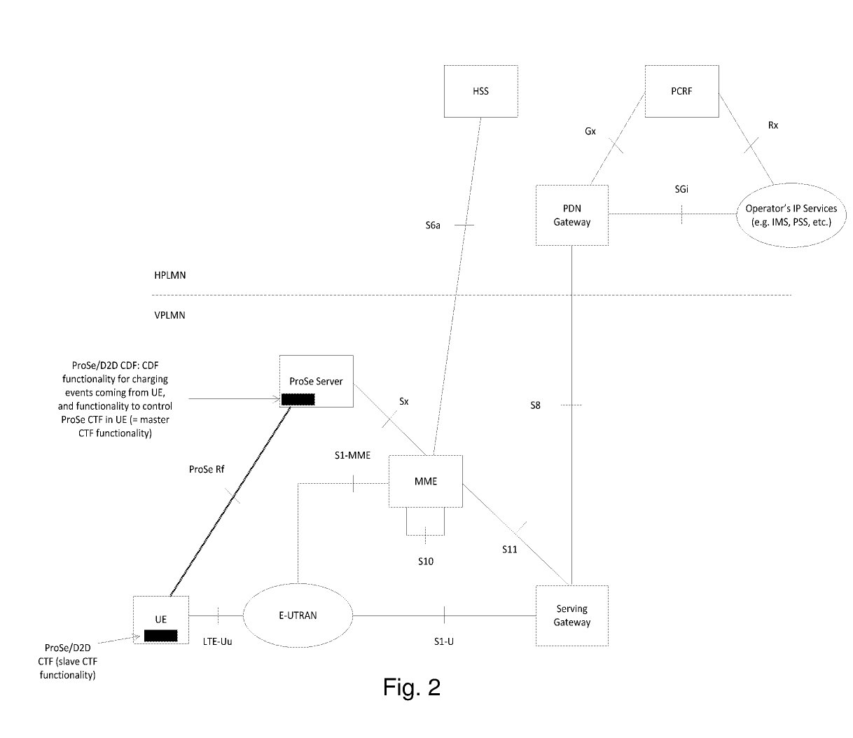

The ProSe/D2D CDF is integrated into a ProSe Server or serving MME of the ProSe UE, as depicted in the ProSe architecture view in FIG. 2 according to some embodiments of the invention. Here, the ProSe Server is logically connected to the MME via Sx interface. The ProSe server is logically connected to the UE via the new ProSe Rf interface. If the UE is roaming, as shown in the example of FIG. 2, the ProSe server and the MME are those of the visited PLMN (VPLMN). The remaining network elements of the VPLMN and the home PLMN (HPLMN) and their connections shown in FIG. 2 are conventionally known for EPC networks.

The slave CTF may be called as a ProSe/D2D CTF since it only generates charging events to the CDF, i.e., it comprises Accounting Data Collection and Accounting Data Forwarding (to ProSe/D2D CDF). In some embodiments of the invention, it is located in the modern application layer or in UICC (USIM). If it is located in the UICC it could be implemented for instance using a SIM Application Toolkit.

A new interface is defined between the ProSe/D2D CDF (Network entity) and ProSe/D2D CTF (UE). The new interface contains the functionality of the Rf reference point, and may additionally comprise CTF control functions. The new interface may be called ProSe Rf. A new protocol is defined that at least carries out transfer of Charging Events from the ProSe/D2D CTF (UE) to the ProSe/D2D CDF. In addition, in some embodiments of the invention, it comprises commands for control and configuration of the ProSe CTF.

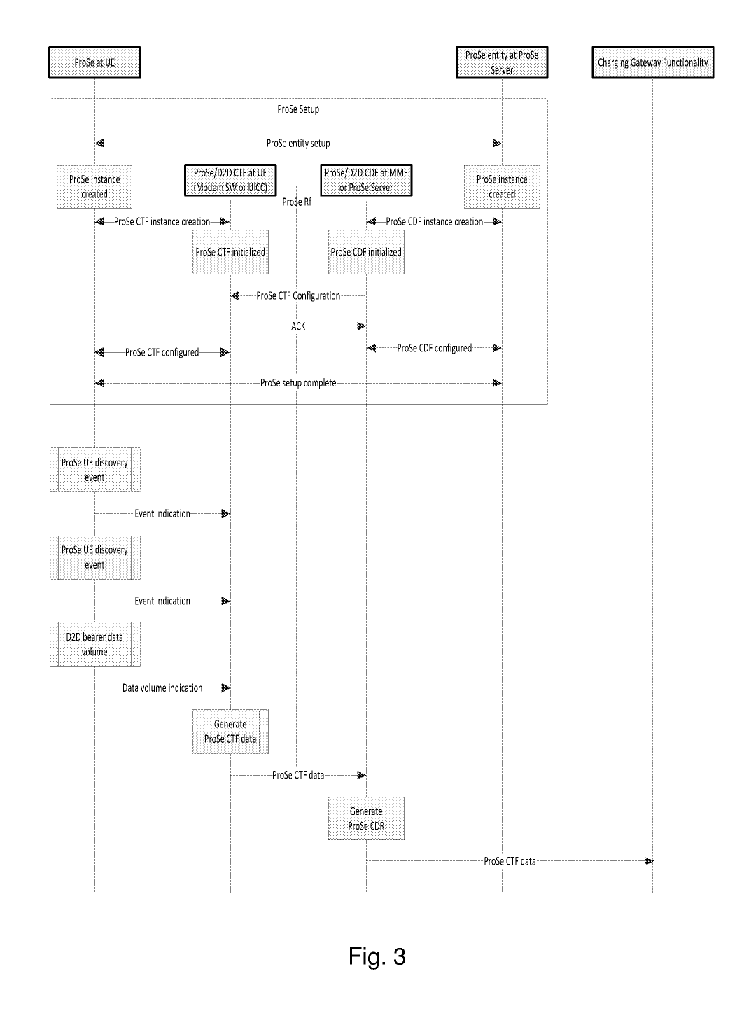

In some embodiments of the invention, the protocol messages over the ProSe Rf interface are conveyed inside containers in RRC/NAS messages. The protocol behaviour according to some embodiments of the invention is illustrated in FIG. 3.

In the top part of FIG. 3, ProSe setup is shown: A ProSe instance is created on both the ProSe at the UE and the ProSe server on the network side. On the UE side, a ProSe CTF instance is created (slave part). On the network side, a ProSe CDF instance is created. In this embodiment, the ProSe CDF instance comprises the CTF master instance. Accordingly, the ProSe CDF instance provides ProSe configuration parameters to the ProSe CTF instance on UE, via the ProSe Rf interface, which are acknowledged. Then, ProSe CTFs and ProSe CDF are configured, and the setup is complete.

During active ProSe operation, as shown in the bottom part of FIG. 3, the ProSe/D2D CTF (slave CTF) collects the events related to ProSe UE discovery and session information (such as bearer data volume) related to ProSe communication as configured by the ProSe/D2D CDF. The ProSe/D2D CTF also sends the collected information to the ProSe CDF, according to its configuration. The ProSe/D2D CDF modifies the received ProSe/D2D data (charging events) from the slave CTF and constructs the CDRs also from ProSe point of view. The ProSe CDF transmits the CDRs to the CGF.

The embodiments hereinabove are related to offline charging. According to some embodiments of the invention, ProSe events may be charged online. Online charging may be implemented by configuring the D2D CTF (UE) to operate in online charging mode and D2D CDF to work as an Online Charging Function for the ProSe.

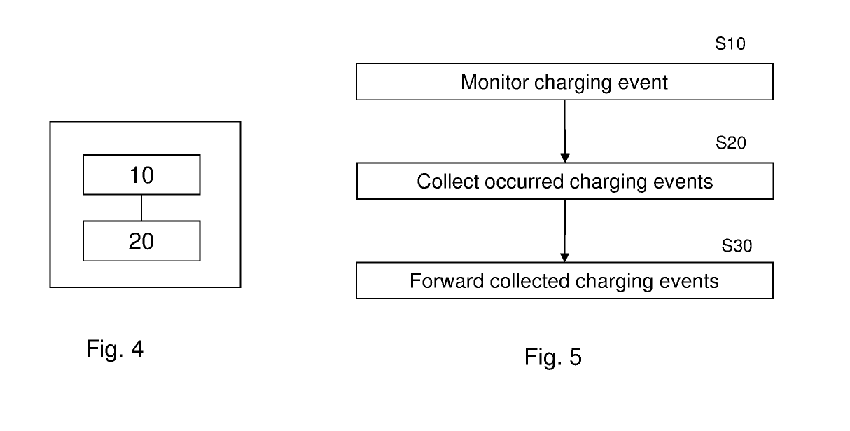

FIG. 4 shows an apparatus according to an embodiment of the invention. The apparatus may be a terminal such as a UE or a part thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises a processing system and/or at least one processor 10 and at least one memory 20. The at least one memory 20 includes computer program code, and the at least one processor 10, with the at least one memory 20 and the computer program code is arranged to cause the apparatus to perform monitoring (S10) if (or ‘whether’) a charging event related to a proximity service performed by the apparatus occurs. The proximity service may be a D2D communication. Then, the apparatus collects the occurred charging event(s) (S20), and forwards the collected charging event(s) to a charging data function (S30). The charging data function may be implemented on the network side.

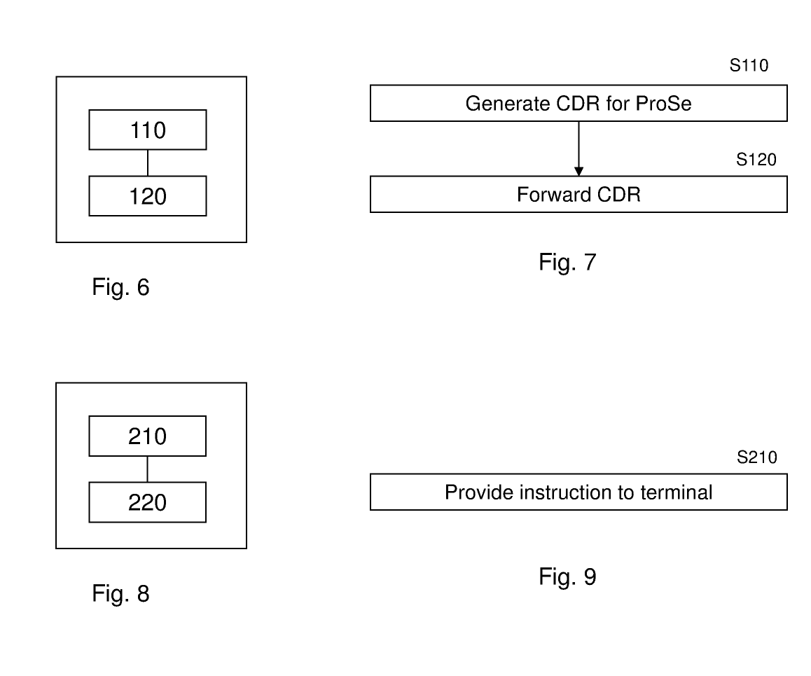

FIG. 6 shows an apparatus according to an embodiment of the invention. The apparatus may be a charging data function or a part thereof. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises a processing system and/or at least one processor 110 and at least one memory 120. The at least one memory 120 includes computer program code, and the at least one processor 110, with the at least one memory 120 and the computer program code is arranged to cause the apparatus to generate (S110) a charging data record based on at least one charging event related to a proximity service of a terminal device, wherein the at least one charging event is received from the terminal device. Then, the apparatus forwards the charging data record to a charging gateway function (S120).

FIG. 8 shows an apparatus according to an embodiment of the invention. The apparatus may be a master of a charging trigger function such as an administrative function or a part thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises a processing system and/or at least one processor 210 and at least one memory 220. The at least one memory 220 includes computer program code, and the at least one processor 210, with the at least one memory 220 and the computer program code is arranged to cause the apparatus to provide (S210) an instruction to a terminal device to adapt its charging trigger function related to a proximity service executed by the terminal such as D2D communication. The instruction may be related to at least one of monitoring if a charging event occurs, wherein the charging event is related to the proximity service, collecting the monitored occurred at least one charging event, and forwarding the collected at least one charging event to a charging data function.

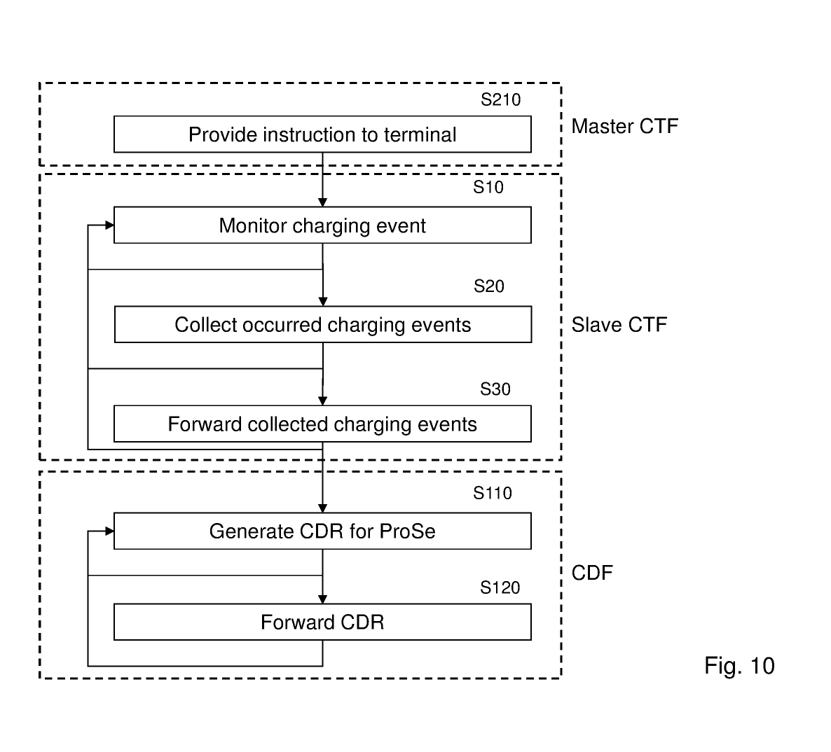

FIG. 10 shows a method according to some embodiments of the invention. This method comprises the methods according to FIGS. 5, 7, 9. Corresponding steps are designated with the same reference signs as in the former figures. Substantially, the flow chart of FIG. 10 corresponds to the message flow of FIG. 3.

A master CTF provides an instruction to a slave CTF (S210), as explained with respect to FIG. 9. Thus, the slave CTF such as a terminal is configured according to the instruction.

Accordingly, the slave CTF monitors charging events (S10), collects the charging events (S20), and forwards the collected charging events to a CDF (S30). The sequence of steps or a part of the sequence may be continuously repeated. Typically, as shown in FIG. 10, each repetition starts with monitoring charging events (S10). The forwarding step (S30) may be performed in parallel to the monitoring step (S10) and/or the collecting step (S20).

The CDF receives the collected CDRs from the slave CTF and generates corresponding CDRs for ProSe (S110). Then, the CDF forwards the CDR e.g. to a CGW (S120). The sequence of steps or a part of the sequence may be continuously repeated. Typically, as shown in FIG. 10, each repetition starts with generating CDRs (S110). The forwarding step (S120) may be performed in parallel to the generating step (S110).

Embodiments of the invention are described based on an LTE-A system but embodiments of the invention may be applied to other radio access technologies such as LTE, WiFi, WLAN, UMTS, HSPA, if device to device communication may be employed.

A terminal may be a machine type device, a user equipment, a mobile phone, a laptop, a smartphone, a tablet PC, or any other device that may attach to a mobile network. A base station may be a NodeB, an eNodeB or any other base station of a radio network.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that example embodiments of the present invention provide, for example a charging trigger slave function or a component thereof, an apparatus such as a terminal or a UE embodying the same, a method for controlling and/or operating the same, and computer program(s) controlling and/or operating the same as well as mediums carrying such computer program(s) and forming computer program product(s).

According to the above description, it should thus be apparent that example embodiments of the present invention provide, for example a charging trigger master function or a component thereof, an apparatus such as a server or a mobility management entity embodying the same, a method for controlling and/or operating the same, and computer program(s) controlling and/or operating the same as well as mediums carrying such computer program(s) and forming computer program product(s).

According to the above description, it should thus be apparent that example embodiments of the present invention provide, for example a charging data function or a component thereof, an apparatus such as a server or a mobility management entity embodying the same, a method for controlling and/or operating the same, and computer program(s) controlling and/or operating the same as well as mediums carrying such computer program(s) and forming computer program product(s).

According to embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processing system, processor or other circuitry may refer to one or more of the following: (a) hardware-only circuit implementations (such as implementations in only analogue and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the ideas of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. Apparatus for use in charging of a proximity service for a terminal device, the apparatus comprising a processing system configured to cause the apparatus to:
monitor whether a charging event related to a proximity service performed by the apparatus occurs;
collect the occurred at least one charging event; and
forward the collected at least one charging event to a charging data function.

2. Apparatus according to claim 1, wherein:
the proximity service comprises a device to device communication with a terminal device,
the device to device communication is not conveyed via a communication network and uses a first radio resource, and
the first radio resource is assigned for a network-conveyed communication with the communication network.

3. Apparatus according to claim 1, wherein the processing system is configured to cause the apparatus to adapt at least one of the monitoring, the collecting, and the forwarding based on an instruction received from a master function.

4. Apparatus according to claim 2, wherein the processing system is configured to cause the apparatus to perform the forwarding using a second radio resource assigned to the communication network.

5. Apparatus according to claim 2, wherein the processing system is configured to cause the apparatus to receive the instruction via a third radio resource assigned to the communication network.

6. Apparatus according to claim 1, wherein the processing system is configured to cause the apparatus to:
determine whether a charge of the monitored charging event exceeds a limit based on a limit indication received from the charging data function; and
inhibit executing the proximity service if the charge exceeds the limit.

7. Apparatus according to claim 1, wherein the processing system is configured to cause the apparatus to operate under a long term evolution standard or a long term evolution advanced standard.

8-10. (canceled)

11. Apparatus for use in charging of a proximity service for a terminal device, the apparatus comprising a processing system configured to cause the apparatus to:
generate a charging data record based on at least one charging event related to a proximity service of a terminal device, wherein the at least one charging event is received from the terminal device; and forward the charging data record to a charging gateway function.

12. Apparatus according to claim 11, wherein the proximity service comprises a device to device communication.

13-17. (canceled)

18. A method for use in charging of a proximity service for a terminal device, the method comprising:
monitoring if a charging event related to a proximity service performed by an apparatus performing the method occurs;
collecting the occurred at least one charging event;
forwarding the collected at least one charging event to a charging data function.

19. A method according to claim 18, wherein:
the proximity service is a device to device communication with a terminal device,
the device to device communication is not conveyed via a communication network and uses a first radio resource, and
the first radio resource is assigned for a network-conveyed communication with the communication network.

20. A method according to claim 18, further comprising adapting at least one of the monitoring, the collecting, and the forwarding based on an instruction received from a master function.

21. A method according to claim 19, wherein the forwarding uses a second radio resource assigned to the communication network.

22. A method according to claim 20, further comprising receiving the instruction via a third radio resource assigned to the communication network.

23. A method according to claim 18, further comprising:
determining whether a charge of the monitored charging event exceeds a limit based on a limit indication received from the charging data function; and
inhibiting executing the proximity service if the charge exceeds the limit.

24. A method according to claim 18, performed under a long term evolution standard or a long term evolution advanced standard.

25. A method according to claim 19, performed by a terminal comprising at least one radio interface configured to perform, using the first radio resource, the proximity service and the network-conveyed communication.

26-29. (canceled)

30. A method for use in charging of a proximity service for a terminal device, the method comprising providing an instruction to a terminal device to adapt at least one of:
monitoring whether a charging event occurs, wherein the charging event is related to a proximity service executed by the terminal device;
collecting the occurred at least one charging event; and
forwarding the collected at least one charging event to a charging data function.

31. A method according to claim 30, wherein the instruction comprises at least one of setting up the monitoring, setting up the collecting, and setting up the forwarding.

32. A method according to claim 30, further comprising:
generating a charging data record based on the forwarded at least one charging event, wherein the forwarded at least one charging event is received from the terminal device;
forwarding the charging data record to a charging gateway function.

33-36. (canceled)
